(19) United States
(12) Patent Application Publication
(10) Pub. No.: US 2010/0084462 A1
(43) Pub. Date: Apr. 8, 2010

(54) SYSTEMS AND METHODS FOR SECURE PHOTO IDENTIFICATION AT POINT OF SALE

(76) Inventors: German Scipioni, San Jose, CA (US); Matthew Mengerink, (US)

Correspondence Address: Haynes and Boone, LLP;IP Section, 2323 Victory Avenue, SUITE 700, Dallas, TX, 75219, US

(21) Appl. No.: 12/244,627

(22) Filed: Oct. 2, 2008

(51) Int. Cl. G06F 19/00

(52) U.S. Cl. 235/380

(57) ABSTRACT

A method for verifying the identity of an individual at a selected location, such as a point of sale (POS), includes storing a photograph of the individual with an associated verifier, such as the individual's verified name, at a remote service provider. A request for a photograph of the individual having the associated verifier is transmitted from the selected location to the remote service provider via a secure data communication network. In response to the request, the service provider matches the verifier with the verifier stored in the database and transmits the photograph associated therewith back to the selected location via the network. The individual's photograph is displayed at the selected location and used by a merchant or the like to verify the identity of the individual.

### BRIEF DESCRIPTION OF THE INVENTIONS

This invention generally relates to systems and methods for identifying individuals, and more particularly, to systems and methods for identifying a customer at a point of sale (POS) by means of a photograph of the customer provided by a remote, trusted source via a secure network.

### BACKGROUND

In a familiar scenario involving the purchase of goods or services, a buyer or customer presents a seller or merchant with a payment card, typically a debit or credit card having, e.g., a magnetically encoded strip on its surface, and the card is “swiped” or scanned with another device usually provided by the seller, e.g., a “card reader,” that reads the card to obtain the buyer's identity and account number at an “issuer” institution, such as a bank, credit card company or other service provider, which the buyer wishes to use to pay for the goods or services. The buyer may then be presented with a “promise to pay” form that the buyer signs with his or her signature to authenticate and confirm the transaction.

It is conventional in such scenarios for the buyer to present some means for verifying his or her identity, such as a driver's license, an identity card, a passport or other device issued by a trusted source that typically includes a photograph of the buyer that the seller can compare with the user of the card at the POS to verify the user's identity. Indeed, some payment cards are imprinted with a photograph of the owner of the card. Unfortunately, it is possible for fraudulent purposes to alter such identification devices, or to create forgeries thereof, in which the photograph on the card is not that of the card's true owner.

A need therefore exists for simple, reliable methods and systems that enable the identity of a customer to be verified at a point of sale (POS) by means of a photograph of the customer that is provided by a remote, trusted source via a secure network, rather than by a photograph on an identification device that potentially has been altered or forged.

### SUMMARY

In accordance with various aspects of the present invention, systems and methods are provided that enable the identity of a customer to be verified at a point of sale (POS) by means of a photograph of the customer that is provided by a trusted source via a secure network.

In one example embodiment, a method for verifying the identity of an individual at a selected location comprises reading an identification device of the individual, such as a debit or a credit card, to obtain an ostensible identifier of the individual therefrom, such as the individual's name, retrieving a photograph associated with the ostensible identifier from a remote location, displaying the photograph at the selected location, and comparing the displayed photograph to the individual to verify the identity of the individual.

A better understanding of the above and many other features and advantages of the novel photo-identification methods and systems of the present invention may be obtained from a consideration of the detailed description of some example embodiments thereof below, particularly if such consideration is made in conjunction with the several views of the appended drawings, wherein like elements are referred to by like reference numerals throughout.

### BRIEF DESCRIPTION OF THE DRAWINGS

FIG. 1 is a functional block diagram of an example embodiment of a system for verifying the identity of an individual at a selected location by means of a photograph in accordance with the present invention;

FIG. 2 is a flow diagram of a example embodiment of method for verifying the identity of an individual at a selected location by means of a photograph in accordance with the present invention;

FIGS. 3A and 3B are perspective views of an example embodiment of a device for verifying the identity of an individual at a selected location by means of a photograph in accordance with the present invention, respectively showing the device prepared to read a payment card of an individual whose identity is to be verified, and displaying a photograph of the individual after reading the individual's payment card.

### DETAILED DESCRIPTION

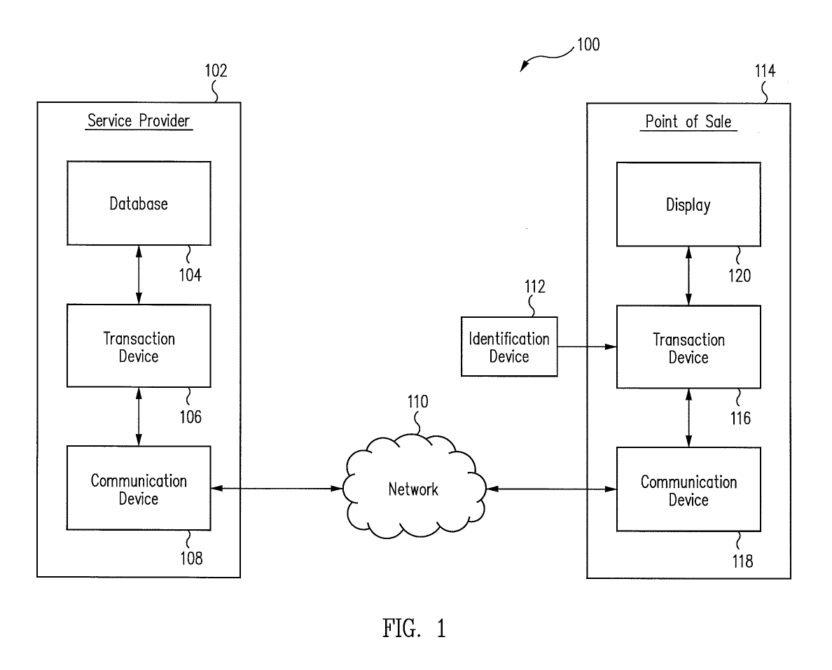

An example embodiment of a system 100 for verifying the identity of an individual at a selected location, e.g., at a point of sale (POS), by means of a photograph of the individual is illustrated in the functional block diagram of FIG. 1.

With reference to FIG. 1, the example system 100 comprises a service provider 102 having a database 104 adapted to store a photograph of an individual who, from time to time, needs to have his or her identity verified at a selected location that is remote from the service provider, for example, at a point of sale (POS) 114, such as at a supermarket, restaurant, gas station, night club, theme park, ticket window, and the like.

In one embodiment, the service provider 102 may limit its services exclusively to the provision of photo-identification (Photo-ID) services, but more advantageously, the service provider may comprise a financial institution, such as a bank, credit card provider, e.g., Visa or MasterCard, or a payment service provider, such as PayPal, which offers the Photo-ID service as an ancillary, value-added service to its regular financial service offerings.

In addition to a database 104 for storing photographs of individuals, the example service provider 102 of FIG. 1 also includes a transaction device 106 and a communication device 108. The transaction device 106 is operable to, inter alia, retrieve a selected photograph from the database 106 and transmit it via the communication device and an associated secure data communication network 110 to the POS 114. In one embodiment, the transaction device 106 comprises a computer programmed to operate as a data server, and the communication device 108 comprises a modem that enables the service transaction device to communicate with a corresponding communication device 116 located at the POS 114. In another embodiment, e.g., a financial service provider, the service provider transaction device may be further operable to, for example, effect an electronic payment from a buyer to a seller for goods or services.

As will be appreciated, before the system 100 can be used to verify the identity of an individual reliably, it is necessary store a photograph of the individual in the database 104 of the service provider 102. In one embodiment, this database provisioning or “account setup” procedure involves first verifying the identity of the individual, then taking a picture of the individual and storing the photograph in the database in association with a unique “identifier” of the individual, e.g., the individual's true or verified name. The identity verification step can be effected in a manner typically employed by merchants and the like, for example, by using a conventional identification device, such as a driver's license, birth certificate, passport, immigration card or the like, issued by a governmental entity. Alternatively, however, the provisioning step may involve even higher levels of identity confirmation than are ordinarily required by merchants, for example, fingerprinting and/or background checks carried out by private and/or governmental investigative agencies, depending on the degree of identity verification demanded. For example, an employer in a sensitive industry, such as the defense industry, may wish to use the system 100 to verify the identity of employees before admitting them into restricted areas of the company's facilities, and may wish to effect a thorough background check of the employee before adding him or her to a list of persons authorized to enter such premises.

In addition to the individual's photograph and verified name, other information pertaining to the individual can also be stored in the database 104 of the service provider 102 at the time of setup, such as the individual's date of birth (DOB), residence, citizenship and/or credit rating, and this information can also be transmitted, along with the individual's photograph, to a remote location and displayed there to verify a corresponding characteristic of the individual. For example, the individual's DOB can be displayed to a waiter or bartender at a location selling alcoholic beverages to verify that the individual is of legal drinking age.

In the example embodiment of FIG. 1, after the individual's photograph, unique identifier and other optional characteristics have been associated with each other and stored in the database 104 of the service provider 102, the service provider may then issue the individual a machine-readable identification device 112 having the individual's “ostensible” name associated therewith. The name associated with identification device is referred to herein as the individual's “ostensible” name because it is subject to verification by a merchant, security guard, or the like, by means of the photograph associated with that name at the service provider.

As discussed above, the identification device 112 may comprise a payment card, e.g., a debit card or a credit card having the individual's ostensible name and financial institution account number associated therewith. The ostensible name of the individual and financial institution can be associated with the identification device in a number of ways, for example, by means of a magnetic strip, a bar code or a radio frequency identification (RFID) device disposed on or embedded in the card. In another embodiment, the identification device 112 may comprise a wristband or a badge that can be worn by the individual and scanned by a suitable reader device to obtain the individual's ostensible identity.

In the example Photo-ID system 100 of FIG. 1, the service provider 102 is operable to cooperate with complementary Photo-ID equipment located at the selected POS 114. As illustrated in FIG. 1, the POS equipment includes a POS transaction device 116 that is operable to communicate with the service provider 102 via a POS communication device 118 and the data communication network 110, as well as a display 120 for displaying a photograph of an individual whose identity is to be verified at the POS. In one embodiment described in more detail below, the POS transaction device 116 comprises a reader that is operable to read the ostensible name of an individual from the individual's identification device 112, e.g., a payment card, wrist band, identity badge, and to transmit a request to the service provider 102 via the network 110 for a photograph of an individual whose verified name matches that read from the individual's identification device.

When the service provider transaction device 106 receives the request from the POS 114, it searches the database 104 for a verified name that matches the ostensible name in the request, and if a match is found, transmits a copy of the photograph associated with the name to the POS transaction device via the secure network 110. If no match is found, the service provider 102 may optionally transmit a corresponding message, e.g., “Name Not Found,” back to the POS transaction device. When the POS transaction device receives the photograph, it causes the photograph to be displayed on the POS display 120, so that the image of the individual depicted in the photograph can be compared to the individual presenting the identification device 112, and the individual's identity thereby verified. In other embodiments, unique identifiers other than a name stored in the identification device 112, such as fingerprints, retinal patterns, voice patterns, and the like, may be used to search the contents of the database 104.

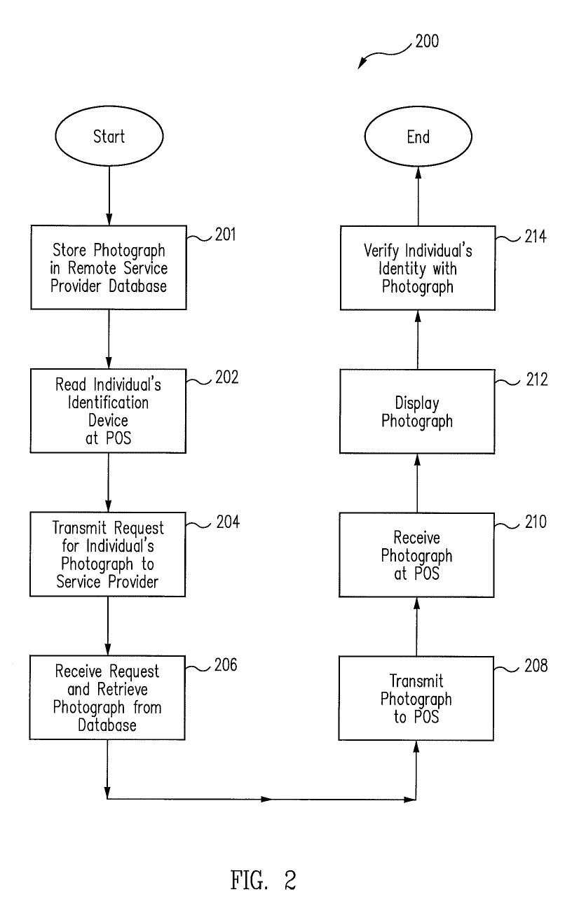

FIG. 2 is a flow diagram of a example embodiment of method 200 for verifying the identity of an individual at a selected location, such as a POS, by means of a photograph using the example system 100 of FIG. 1. The example method begins at step 201 with the one-time “setup” procedure described above in which the service provider 102 verifies the identity, i.e., the true name, of an individual, then takes a picture of the individual and stores the photograph in association with the verified name in the service provider database 106.

At step 202 of the example method, an individual whose identity is to be verified at a location, such as a POP 114 remote from the service provider 102, presents an identification device 112, such as a payment card of the type described above, e.g., to pay for goods or services at the POS. A POS transaction device 116, such as the card reader described above, then reads the individual's ostensible identity, i.e., name, from the card, and at step 204, transmits a request for a photograph matching the name via the network 110 to the transaction device 106 of the service provider 102.

At step 206 of the method 200, the service provider transaction device 106 receives the request from the POS transaction device 115 and effects a search of the database 104 for a verified name that matches the ostensible name in the request. As described above, if a match is found, at step 208, the service provider transaction device 106 transmits a copy of the photograph associated with the individual's verified name back to the POS transaction device via the network 110. As above, if no match is found, the service provider 102 may transmit a corresponding message, e.g., “Name Not Found,” back to the POS transaction device, and optionally, may prompt the POS transaction device to re-transmit the Photo-ID request.

At step 210, the POS transaction device 116 receives the photograph transmitted by the service provider 102, and at step 212, displays the photograph on the POP display 120. At step 214, the displayed photograph is used by a merchant, gatekeeper, or the like, to verify the identity of the individual.

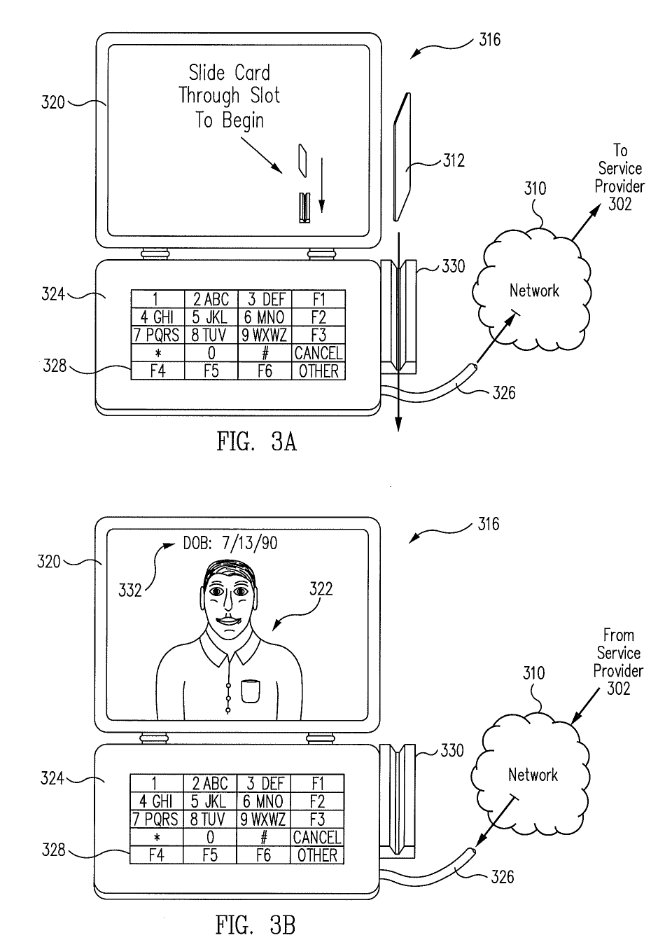

FIGS. 3A and 3B are perspective views of an example embodiment of a POS transaction device 316 useful for verifying the identity of an individual at a POS 114 by means of a photograph in the context of the example system 100 and method 200 described above, respectively showing the device prepared to read a payment card 312 of an individual whose identity is to be verified, and displaying a photograph 322 of the individual after reading the individual's card and receiving the corresponding Photo-ID from the service provider.

In the particular embodiment illustrated in FIGS. 3A and 3B, the POS transaction device 316 includes a display 320, which may comprise, for example, a flat panel liquid crystal display (LCD), for displaying the individual's identification photograph 322, and a base 324 that may contain a communication device 318, such as a modem (not seen in the figures). The communication device enables the POS transaction device to communicate through a suitable medium 326, which may be either wired or wireless, via the data communication network 310, which, as discussed above, may comprise a public or private data communication network, such as the internet or a public switched telephone network (PSTN), with the corresponding transaction device 106 of the remote service provider 102 (not seen in FIGS. 3A, 3B).

Alternatively or additionally, the base 324 may be coupled or ancillary to a cash- or other type of transaction-register (not illustrated) also located at the POP 114. The POP transaction device 316 may also include an alphanumeric input keypad 328 of a known type for the input of transaction data by the user, such as a password or a personal identification number (PIN), to effect financial transactions.

In the particular embodiment illustrated, the individual's identification device 312 comprises a payment card 312 on which is disposed a magnetic strip containing the individual's ostensible name and payment service provider, and accordingly, the POS transaction device 316 is provided with a corresponding magnetic strip card reader 330 through which the card is slid, or “swiped,” in a familiar manner, to enable the POS transaction device to read the name. In FIG. 3A, the POS device 316 is shown prompting an individual card user to slide his or her card 312 through the reader 330 to begin, for example, a purchase transaction.

As described above, when the individual's ostensible name is read from the card 312, the POS transaction device 316 transmits a request for a photograph of the individual named on the card to the service provider 102 via the data communication network 310, and the service provider 102 searches the Photo-ID database 104 for a verified name that matches the ostensible name. If a match is found, the service provider transmits the photograph 322 associated with the verified name to the POS 114, where, as illustrated in FIG. 3B, it is displayed on the display 320 of the POS transaction device 316 and used to verify the identity of the individual, and optionally, to verify one or more characteristics of the individual, such as his or her DOB 332.

As will be appreciated, in the example Photo-ID system 100 of FIG. 1, it is strongly desirable from the standpoint of both privacy and security that all communications via the network 110 between the respective transaction devices 106 and 116 of the service provider 102 and the POS 114 be secured by strong encryption systems. This may be effected in a variety of known ways, including the provision of, for example, virtual private network (VPN) software and hardware, and the use of cryptographic communication protocols, such as Transport Layer Security (TLS) or Secure Sockets Layer (SSL) protocols, for communications through the internet.

Although the novel identity verifying methods and systems of the present invention have been described and illustrated herein with reference to certain specific example embodiments thereof, it should be understood that a wide variety of modifications and variations may be made to these without departing from the spirit and scope of the invention.

For example, in a more sophisticated embodiment of the system 100, a unique physiological identifier of the individual to be identified, such as a fingerprint, retinal pattern or voiceprint of the person, can be used in substitution for or in addition to the individual's identification device 112. In this embodiment, the individual's photograph is stored in association with the selected physiological identifier in the service provider database 104 at the time of setup, and the POS transaction device 116 is equipped with a scanner or reader adapted to read the selected identifier, e.g., a fingerprint scanner, a retinal scanner or a voiceprint scanner at the POS, and to request a photograph from the service provider that matches that identifier.

In other embodiments, the identifying photograph of the individual, in addition to being displayed at the POS for identification purposes, can be printed on a receipt or other form, such as a boarding pass or an entry permit, for future use by the individual and/or the issuer of the form. Additionally, the photograph, in digital format, can be stored in a transactional database in association with other data pertaining to a particular transaction and used subsequently, for example, to provide photographic evidence of the individual's participation in the particular transaction.

In light of the foregoing examples, the scope of the present invention should not be limited by that of the specific example embodiments described and illustrated herein, but rather, should be commensurate with that of the claims appended hereafter and their functional equivalents.

What is claimed is:

1. A method for verifying the identity of an individual at a selected location, the method comprising:
reading an identification device of the individual to obtain an ostensible identifier of the individual therefrom;
retrieving a photograph associated with the ostensible identifier from a remote location;
displaying the photograph at the selected location; and,
comparing the displayed photograph to the individual to verify the identity of the individual.

2. The method of claim 1, wherein the ostensible identifier of the individual comprises at least one of the group consisting of a name, a fingerprint, a voice print and a retinal pattern.

3. The method of claim 1 wherein the identification device comprises a card, a wristband or a badge.

4. The method of claim 1, wherein the retrieving of the photograph comprises transmitting the ostensible identifier to the remote location.

5. The method of claim 4, wherein the ostensible identifier and the photograph are respectively transmitted to and retrieved from the remote location via a data communication network.

6. Apparatus for verifying the identity of an individual at a selected location, the apparatus comprising:
a reader for reading an identification device of the individual to obtain an ostensible identifier of the individual therefrom;
means for retrieving a photograph associated with the ostensible identifier from a remote location; and,
a display for displaying the retrieved photograph at the selected location.

7. The apparatus of claim 6, wherein:
the ostensible identifier of the individual comprises a name;
the individual identification device comprises a card, a wristband or a badge; and,
the ostensible identifier is associated with the identification device by means of at least one of the group consisting of a magnetic strip, an RFID device and a bar code.

8. The apparatus of claim 7, wherein the reader comprises a magnetic strip reader, an RFID reader or a bar code reader.

9. The apparatus of claim 6, wherein the reader comprises a fingerprint scanner, a voiceprint scanner or a retinal scanner.

10. The apparatus of claim 6, wherein the identification device of the individual comprises a payment card, a debit card or a credit card.

11. The apparatus of claim 6, wherein the means for retrieving the photograph comprises a data communication device adapted to communicate with the remote location via a data communication network.

12. The apparatus of claim 11, wherein communications between the selected and remote locations are encrypted.

13. The apparatus of claim 6, further comprising a printer for printing the photograph on a form at the selected location.

14. A method for verifying the identity of an individual at a selected location, the method comprising:
storing a photograph of the individual in association with a unique identifier of the individual in a database at a remote location;
receiving a request from the selected location for a photograph of an individual having the unique identifier associated therewith;
retrieving the photograph having the associated unique identifier from the database; and,
transmitting the photograph to the selected location.

15. The method of claim 14, further comprising providing the individual with an identification device having the unique identifier associated therewith.

16. The method of claim 14, wherein the storing of the photograph comprises:
verifying the identity of the individual;
taking a photograph of the individual;
associating a verified name of the individual with the photograph taken; and,
storing the associated photograph and verified name in the database.

17. The method of claim 14, wherein the storing of the photograph comprises:
scanning the individual to obtain a unique physiological identifier thereof;
taking a photograph of the individual;
associating the scanned physiological identifier with the photograph taken; and,
storing the photograph and associated physiological identifier in the database.

18. The method of claim 14, further comprising:
storing additional information pertaining to the individual in the database; and,
transmitting the additional information to the remote location along with the photograph in response to the request.

19. The method of claim 18, wherein the additional information comprises at least one of the group consisting of the date of birth (DOB), residence, citizenship and a credit rating of the individual.

20. Apparatus for verifying the identity of an individual at a selected location, the apparatus comprising:
means for storing a photograph of the individual in association with a unique identifier of the individual at a remote location;
means for receiving a request from the selected location for a photograph of an individual having the unique identifier associated therewith;
means for retrieving the photograph having the associated unique identifier from the storing means; and,
means for transmitting the photograph to the remote location.

21. The apparatus of claim 20, further comprising a personal identification device capable of being carried by the individual, the device including means for associating the unique identifier therewith.

22. The apparatus of claim 21, wherein the unique identifier comprises the individual's name, and wherein the associating means comprises at least one of a magnetic strip, an RFID device or a bar code.

23. The apparatus of claim 20, wherein the storing means comprises a database.

24. The apparatus of claim 20, wherein the means for receiving the request comprises a data communication device in communication with the selected location via a data communication network.

25. The apparatus of claim 20, wherein at least one of the request receiving means and the photograph retrieving means comprises a data server.
